(19) United States
(12) Patent Application Publication
(10) Pub. No.: US 2026/0066395 A1
(43) Pub. Date: Mar. 5, 2026

(54) BATTERY ASSEMBLY

(71) Applicant: SK On Co., Ltd., Seoul (KR)

(72) Inventors: Jeong Won KIM, Daejeon (KR); Yun Joo NOH, Daejeon (KR); Gang U LEE, Daejeon (KR); Kyu Hyun HAN, Daejeon (KR)

(21) Appl. No.: 19/317,154

(22) Filed: Sep. 3, 2025

(30) Foreign Application Priority Data
Sep. 3, 2024 (KR) 10-2024-0119383
Aug. 5, 2025 (KR) 10-2025-0107466

(51) Int. Cl. H01M 10/658; H01M 10/643; H01M 10/647; H01M 50/209; H01M 50/213; H01M 50/242; H01M 50/505

(52) U.S. Cl. CPC H01M 10/658; H01M 10/643; H01M 10/647; H01M 50/209; H01M 50/213; H01M 50/242; H01M 50/505

(57) ABSTRACT

The present disclosure relates to a battery assembly comprising a plurality of battery cells, a receiving case configured to accommodate the plurality of battery cells, an insertion space formed between the plurality of battery cells and the receiving case, and a filler member disposed in the insertion space, wherein the filler member comprises a compressible material.

### CROSS-REFERENCE TO RELATED PATENT APPLICATION

The present application claims priority under 35 U.S.C. § 119(a) to Korean patent application number 10-2024-0119383 filed on Sep. 3, 2024 and Korean patent application number 10-2025-0107466 filed on Aug. 5, 2025 in the Korean Intellectual Property Office, the entire disclosure of which is incorporated by reference herein.

### BACKGROUND OF THE INVENTION

### 1. Field

The present disclosure relates to a battery assembly, and more particularly, to a battery assembly with improved thermal stability.

### 2. Description of the Related Art

Recently, due to fires or explosion accidents occurring during the use of lithium secondary batteries, social concerns regarding the safety of battery use have been increasing. Based on such social concerns, one of the main development tasks of lithium secondary batteries in recent years is to eliminate instability, such as fire or explosion, caused by thermal runaway of battery cells.

In particular, in battery modules/packs, there exists an empty space other than the battery cells, which are the energy source. If a fire occurs due to an external impact or a problem of the battery cell, the flame may be transferred to an adjacent cell through the empty space, thereby increasing the damage caused by the fire. Such a risk of fire can be the greatest obstacle to the electric vehicle market, and thus methods for reducing the spread of fire are being continuously researched.

### SUMMARY OF THE INVENTION

First, according to one aspect of the present disclosure, a task to be solved is to delay (mitigate) or block thermal propagation (TP), in which high-temperature gas generated from a battery cell undergoing thermal runaway among one or more battery cells provided inside a battery assembly, for example, a battery module or a battery pack, is transferred to an adjacent battery cell.

Second, according to another aspect of the present disclosure, a task to be solved is to vent the high-temperature gas generated from a battery cell undergoing thermal runaway along an intended path.

Third, according to still another aspect of the present disclosure, a task to be solved is to increase heat resistance or fire resistance to improve the thermal stability of the battery assembly.

Meanwhile, the battery assembly according to the present disclosure can be widely applied in fields of green technology such as electric vehicles, battery charging stations, energy storage systems (ESS), and other battery-powered technologies including photovoltaics and wind power. In addition, the battery assembly according to the present disclosure can be used in eco-friendly mobility, including electric vehicles and hybrid vehicles, to suppress air pollution and greenhouse gas emissions and thereby prevent climate change.

The battery assembly according to the present disclosure may comprise: a plurality of battery cells; a receiving case accommodating the plurality of battery cells; an insertion space formed between the plurality of battery cells and the receiving case; and a filler member disposed in the insertion space, wherein the filler member may comprise a compressible material.

In one embodiment, the filler member may have at least one of electrical insulation or fire retardancy.

In one embodiment, a volume of the filler member may be maintained at a first volume, and when at least one of the plurality of battery cells expands, the volume may decrease from the first volume according to the expansion of the at least one battery cell.

In one embodiment, the filler member may comprise a plurality of filler members, and when at least one of the plurality of battery cells expands, at least one filler member, which is disposed to correspond to the at least one battery cell among the plurality of filler members, may be deformed from the first volume to a second volume smaller than the first volume.

In one embodiment, the battery assembly according to the present disclosure may further comprise a busbar electrically connected to the plurality of battery cells, and the insertion space may be located between the plurality of battery cells and the busbar.

In one embodiment, the battery assembly according to the present disclosure may further comprise a busbar frame supporting the busbar between the plurality of battery cells and the busbar, and the insertion space may be located between the plurality of battery cells and the busbar frame.

In one embodiment, each of the plurality of battery cells may comprise: an electrode assembly; a cell case accommodating the electrode assembly therein; and a terminal portion electrically connected to the electrode assembly and protruding to an outside of the cell case, and the insertion space may be partitioned into a plurality of separate spaces by the respective terminal portions of the plurality of battery cells.

In one embodiment, the battery assembly according to the present disclosure may further comprise: a busbar electrically connected to the plurality of battery cells; and a busbar frame supporting the busbar between the plurality of battery cells and the busbar, and each of the plurality of separate spaces may be formed by the busbar frame, the respective terminal portion, and the respective cell case of the plurality of battery cells.

In one embodiment, the filler member may comprise a plurality of filler members, and the plurality of filler members may be respectively disposed in at least some of the plurality of separate spaces.

In one embodiment, each of the plurality of filler members may be disposed in the plurality of separate spaces at a predetermined interval along the stacking direction.

In one embodiment, the battery assembly according to the present disclosure may further comprise a heat blocking member disposed between at least one pair of the plurality of battery cells in the stacking direction, wherein the heat blocking member extends parallel to the plurality of battery cells and may be inserted into a filler member among the plurality of filler members, the filler member being disposed to correspond to the heat blocking member.

In one embodiment, the receiving case may comprise: a body bottom side forming a bottom surface of the receiving case; and a first body side and a second body side extending from the body bottom side, facing each other with the plurality of battery cells interposed therebetween in the stacking direction, and forming both side surfaces of the receiving case, and the insertion space may comprise: a first insertion space formed between the plurality of battery cells and the first body side; and a second insertion space formed between the plurality of battery cells and the second body side.

In one embodiment, each of the plurality of battery cells may comprise: an electrode assembly; a cell case accommodating the electrode assembly therein; a first terminal portion electrically connected to the electrode assembly and protruding from the cell case toward the first body side; and a second terminal portion electrically connected to the electrode assembly and protruding from the cell case toward the second body side, and the first insertion space and the second insertion space may be respectively partitioned into a plurality of separate spaces by the respective first terminal portions and the respective second terminal portions of the plurality of battery cells.

In one embodiment, the receiving case may comprise: a receiving body including an opening on one side and accommodating the plurality of battery cells; and a receiving cover coupled to the receiving body and covering the opening, and the filler member may extend in a direction from the receiving body toward the receiving cover.

In one embodiment, the filler member may be injected into the insertion space in a liquid state and then cured.

In one embodiment, the filler member in the liquid state and the cured filler member may have a predetermined resistance value or more.

In one embodiment, a viscosity of the filler member in the liquid state may be 160 cP (centipoise) or more.

In one embodiment, when an elastic restoring force of the filler member is evaluated by a compression test according to ASTM D3574, the filler member may have an elastic restoring force of 10 kPa or more when its volume is compressed by 20%, and an elastic restoring force of 488 kPa or less when its volume is compressed by 70%.

In one embodiment, when an insulation resistance of the filler member is evaluated according to ASTM D149, a resistance value of the filler member may be 100 MΩ or more at a direct current of 500 V.

In one embodiment, the filler member may comprise at least one of foamed urethane, foamed silicone, or a polymer material having a first fire-retardant standard, and the first fire-retardant standard may include a V-O rating in a 94V test (Vertical Burning Test) of UL (Underwriters Laboratories).

First, according to one embodiment of the present disclosure, a task to be solved is to delay (mitigate) or block thermal propagation (TP), in which high-temperature gas generated from a battery cell undergoing thermal runaway among one or more battery cells provided inside a battery assembly, for example, a battery module or a battery pack, is transferred to an adjacent battery cell.

Second, according to another embodiment of the present disclosure, a task to be solved is to vent the high-temperature gas generated from a battery cell undergoing thermal runaway along an intended path.

Third, according to still another embodiment of the present disclosure, a task to be solved is to increase heat resistance or fire resistance to enhance the thermal stability of the battery assembly.

### BRIEF DESCRIPTION OF THE DRAWINGS

FIG. 1 is an embodiment of a battery assembly according to the present disclosure.

FIG. 2 is an embodiment of the battery assembly according to the present disclosure in an exploded view.

FIG. 3 is a top view of the battery assembly according to the present disclosure.

FIG. 4 is an enlarged view of portion S1 of FIG. 3.

FIG. 5 schematically illustrates an embodiment of a filler member accommodated in an insertion space viewed from above.

FIG. 6 illustrates a volume change of the filler member before and after thermal runaway.

FIG. 7 illustrates a part of another embodiment of the battery assembly according to the present disclosure.

FIG. 8 illustrates a part of another embodiment of the battery assembly according to the present disclosure.

FIG. 9 illustrates another embodiment of the battery assembly according to the present disclosure.

FIG. 10 shows results of a cycle test performed using a battery assembly provided with a filler member according to an embodiment of the present disclosure.

FIG. 11 shows results of measuring an elastic restoring force of the filler member when the volume of the filler member is compressed by 20% according to the present disclosure.

FIG. 12 shows results of measuring an elastic restoring force of the filler member when the volume of the filler member is compressed by 70% according to the present disclosure.

FIG. 13 shows results of measuring insulation resistance of the filler member in each state according to an embodiment of the present disclosure.

FIG. 14 is a diagram showing before and after heat source application in a battery assembly including the filler member.

### DETAILED DESCRIPTION

The structural or functional descriptions of embodiments disclosed in the present specification or application are merely illustrated for the purpose of explaining embodiments according to the technical idea of the present disclosure, and the embodiments according to the technical idea of the present disclosure may be implemented in various forms other than the embodiments disclosed in the present specification or application, and the technical idea of the present disclosure should not be construed as being limited to the embodiments described in the present specification or application.

Hereinafter, preferred embodiments of the present disclosure will be described in detail with reference to the accompanying drawings.

The battery assembly 200, 300 according to the present disclosure is a concept collectively referring to a battery module, a battery pack, and an energy storage system (ESS). Accordingly, the battery assembly 200, 300 according to the present disclosure may mean not only a battery module, but also a battery pack or an energy storage system (ESS) accommodating battery cells without a battery assembly, such as Cell to Pack (CTP).

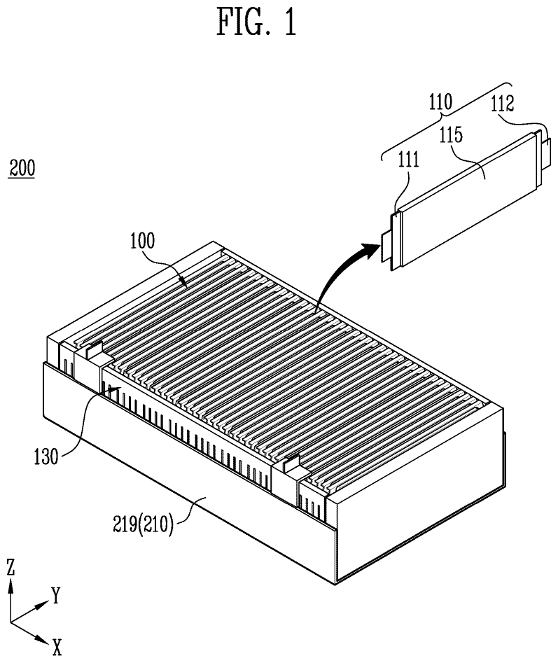

FIG. 1 is an embodiment of a battery assembly 200 according to the present disclosure.

Referring to FIG. 1, the battery assembly 200 may comprise a plurality of battery cells 110, a busbar assembly 130 electrically connecting and supporting the plurality of battery cells 110, and a receiving case 210 accommodating the plurality of battery cells 110.

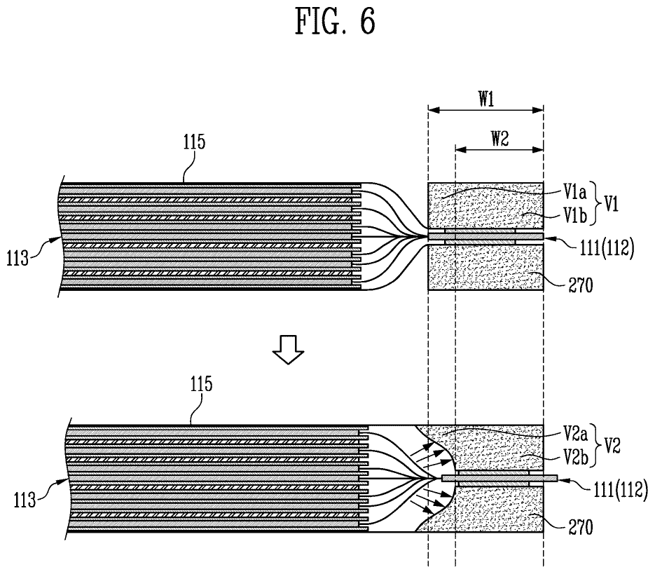

Meanwhile, each of the plurality of battery cells 110 may comprise a cell case 115 including an electrode assembly 113 (see FIG. 6) for producing or storing electrical energy, and terminal portions 111, 112 protruding from the cell case 115 to an outside of the cell case 115.

The cell case 115 further comprises an electrolyte (not shown) in contact with the electrode assembly 113. The electrolyte may be liquid or solid. In addition, when the electrolyte is liquid, the electrode assembly may further comprise a separator for separating the positive electrode and the negative electrode.

Referring to FIG. 1, for example, the cell case 115 may be in a pouch form sealed with a film-type exterior material. However, a form of the battery cell 110 according to the present disclosure is not limited thereto. For example, the form of the battery cell 110 according to the present disclosure may be a prismatic or cylindrical battery cell.

Specifically, the terminal portions 111, 112 may comprise a first terminal portion 111 and a second terminal portion 112 protruding from both side surfaces of the cell case 115 in a direction away from the cell case 115.

Alternatively, the terminal portions 111, 112 may be provided to protrude in the same direction.

Meanwhile, the receiving case 210 may be provided to protect the plurality of battery cells 110 from external impacts such as vibration. The receiving case 210 may comprise a receiving body 219 forming a part of a receiving space 280 accommodating the plurality of battery cells 110, which will be described later.

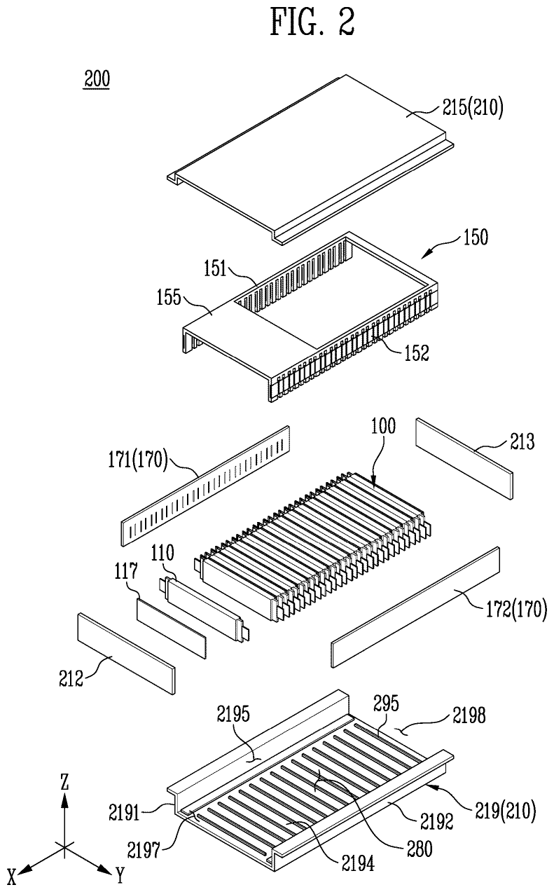

The busbar assembly 130 may comprise a busbar 170 (see FIG. 2) electrically connected to the plurality of battery cells 110, and a busbar frame 150 (see FIG. 2) positioned between the busbar 170 and the plurality of battery cells 110, supporting the busbar 170, and into which the respective terminal portions 111, 112 of the plurality of battery cells 110 are inserted.

An assembled form of the busbar assembly 130 or the busbar 170 with the plurality of battery cells 110 may be referred to as a cell stack 100.

FIG. 2 is an embodiment of the battery assembly 200 according to the present disclosure in an exploded view.

Referring to FIG. 2, the receiving case 210 may comprise a receiving body 219 forming a part of a receiving space 280 accommodating the cell stack 100, and a receiving cover 215 coupled to the receiving body 219 to together form the receiving space 280.

Inside the receiving body 219, the plurality of battery cells 110 may be positioned to overlap along a predetermined stacking direction (for example, the X-direction).

More specifically, the receiving case 210 may comprise an opening 2195 on one side, a receiving body 219 forming the receiving space 280, and a receiving cover 211 coupled to the receiving body 219 to together form the receiving space 280 and cover the opening 2195.

For example, the opening 2195 may be formed on an upper surface of the receiving case 210, but is not limited thereto.

The receiving cover 211 may be coupled to the receiving body 219 to close the opening 2195, which is an opened upper surface, and form the receiving space 280 together with the receiving body 219.

The receiving space 280 may not only accommodate the cell stack 100, but a part of the receiving space 280 may also form an insertion space 288, which will be described later.

Meanwhile, the receiving body 219 may be provided in a channel shape or a U-shape with its upper side opened. Referring to FIG. 2, both side surfaces 2197, 2198 of the receiving body 219 facing each other along the X-direction may also be opened.

That is, the receiving body 219 may comprise a body bottom side 2194 forming a bottom surface of the receiving space 280, and a first body side 2191 and a second body side 2192 extending from corners (not shown) of the body bottom side 2194, the corners being provided parallel along the stacking direction, toward the receiving cover 211.

The first body side 2191 and the second body side 2192 may have their ends bent to form a flange (not shown), for facilitating coupling with the receiving cover 211.

Referring to FIGS. 1 and 2, a height of the receiving body 219 may be smaller than a height of the plurality of battery cells 110. However, this is merely an example, and the height of the receiving body 219 may be equal to or greater than the height of the plurality of battery cells 110.

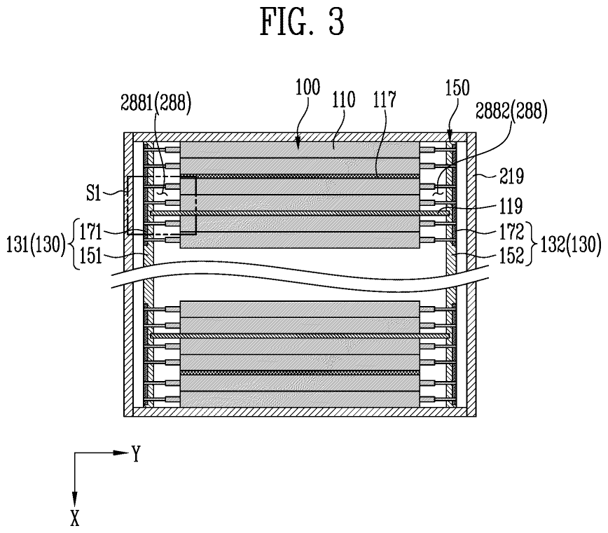

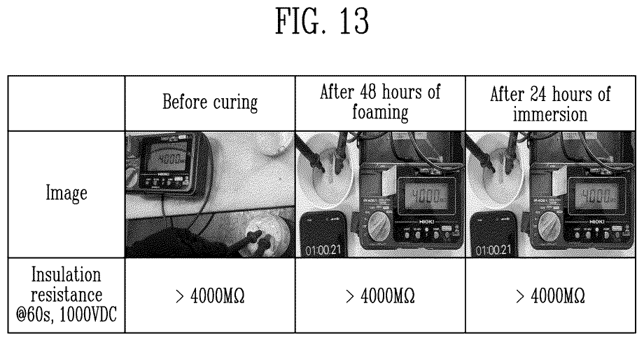

Meanwhile, the cell stack 100 may further comprise a buffer member 117 or a heat blocking member 119 (see FIG. 3) positioned between the plurality of battery cells 110. The buffer member 117 may be positioned between each of the battery cells 110, or may be positioned between battery groups BG1 to BG5 (see FIG. 13) in which the plurality of battery cells 110 are grouped. The same applies to the heat blocking member 119.

The heat blocking member 119 may serve as a thermal barrier to prevent flame or heat from being propagated to another adjacent battery cell 110 when thermal runaway occurs in one of the battery cells 110.

The cell stack 100 may comprise at least one buffer member 117. Likewise, the cell stack 100 may comprise at least one heat blocking member 119. Alternatively, the heat blocking member 119 may simultaneously perform both a heat blocking function and a buffering function.

To this end, the heat blocking member 119 may be formed in a multilayer structure along the stacking direction of the plurality of battery cells 110. That is, one of the layers of the multilayer structure may be formed of a fire-retardant material (or a refractory material). In addition, another layer of the multilayer structure may serve to reduce pressure exerted on another battery cell 110 when the battery cell 110 swells.

The plurality of battery cells 110 and the plurality of heat blocking members 119 may be disposed between the plurality of battery cells 110. The heat blocking member 119 may be formed of a refractory (heat-resistant or fire-retardant) material. For example, the heat blocking member 119 may comprise a refractory polymer, or a material such as mica.

Meanwhile, referring to FIG. 2, the battery assembly 200 may further comprise end plates 212, 213 at both ends of the cell stack 100 along the stacking direction. The end plates 212, 213 may be provided at both ends of the cell stack 100 and connected to both side surfaces 2197, 2198 of the receiving body 219. The end plates 212, 213 serve to prevent both side surfaces of the cell stack 100 from being exposed to the outside.

Accordingly, the end plates 212, 213 may be disposed at outermost sides of the plurality of battery cells 110 along the direction (X-direction) in which the plurality of battery cells are stacked.

Meanwhile, the battery assembly 200 may comprise a busbar 170 electrically connected to the plurality of battery cells 110. In addition, the battery assembly 200 may further comprise a busbar frame 150 supporting the busbar 170 and the plurality of battery cells 110. As described above, the busbar 170 and the busbar frame 150 may collectively be referred to as a busbar assembly 130 (see FIG. 3).

The busbar assembly 130 may comprise a first busbar frame 151 and a second busbar frame 152 extending along the stacking direction of the plurality of battery cells 110 with the plurality of battery cells 110 interposed therebetween.

In addition, the busbar assembly 130 may further comprise a support frame 155 positioned at one side of the busbar assembly 130 and connecting the first busbar frame 151 and the second busbar frame 152.

The busbar assembly 130 is described in a case where the terminal portions 111, 112 are respectively positioned on opposite sides of the cell case 115. Alternatively, when the terminal portions 111, 112 are positioned on one side of the cell case 115 to face the same direction, the busbar frame 150 may be positioned on one side (for example, an upper side) of the cell case 115 and electrically connected to the terminal portions 111, 112.

The support frame 155 may serve to prevent deformation of and support the first busbar frame 151 and the second busbar frame 152. In addition, a part of an electric device for sensing and controlling the plurality of battery cells 110 may be disposed on the support frame 155.

Referring to FIG. 2, a shape of the busbar assembly 130 may be a tunnel shape. Further, along the stacking direction, lengths of the first busbar frame 151 and the second busbar frame 152 may be longer than a length of the support frame 155.

That is, the support frame 155 may be connected to the first busbar frame 151 and the second busbar frame 152 to cover an upper portion of the plurality of battery cells 110. That is, the support frame 155 may not only cover a part of the upper portion of the plurality of battery cells 110, but may cover all of the upper portion.

Referring to FIG. 2, the busbar 170 may comprise a first busbar 171 supported by the first busbar frame 151 and electrically connected to the first terminal portion 111, and a second busbar 172 supported by the second busbar frame 152 and electrically connected to the second terminal portion 112.

The first busbar 171 and the second busbar 172 may each be positioned in a direction away from the plurality of battery cells 110 relative to the first busbar frame 151 and the second busbar frame 152, respectively.

That is, the first busbar 171 may be positioned between the plurality of battery cells 110 and the first busbar frame 151, and the second busbar 172 may be positioned between the plurality of battery cells 110 and the second busbar frame 152.

Referring to FIG. 2, the first busbar 171 may be in contact with an outer side of the first busbar frame 151, and the second busbar 172 may be in contact with an outer side of the second busbar frame 152.

The first busbar 171 may be positioned closer to the first body side 2191 than the first busbar frame 151. Likewise, the second busbar 172 may be positioned closer to the second body side 2192 than the second busbar frame 152. Accordingly, the first terminal portion 111 and the second terminal portion 112 may be respectively inserted into slit holes (not shown) formed in the first busbar frame 151 and the second busbar frame 152, and may be electrically connected to the first busbar 171 and the second busbar 172. However, this is merely an example, and the first terminal portion 111 and the second terminal portion 112 may also be electrically connected to the first busbar 171 and the second busbar 172 in other ways.

Meanwhile, the battery assembly 200 may further comprise a heat dissipation portion 295 positioned between the body bottom side 2194 and the plurality of battery cells 110 to transfer heat generated from the plurality of battery cells 110 to the outside of the battery assembly 200.

The heat dissipation portion 295 may be provided as an adhesive material having thermal conductivity, for example, a heat dissipation adhesive. Accordingly, the plurality of battery cells 110 may be adhered to the body bottom side 2194 through the heat dissipation portion 295. To this end, the heat dissipation portion 295 may be sprayed or applied onto the body bottom side 2194.

FIG. 3 is a top view of the battery assembly 200 according to the present disclosure.

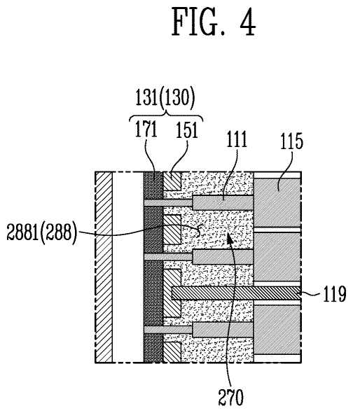

The battery assembly 200 according to the present disclosure may comprise a plurality of battery cells 110 stacked in a predetermined stacking direction, a receiving case 210 accommodating the plurality of battery cells 110, an insertion space 288 formed between the plurality of battery cells 110 and the receiving case 210, and a filler member 270 (see FIG. 4) disposed in the insertion space 288.

In addition, the filler member 270 may comprise a compressible material.

Alternatively, the filler member 270 may be a compressible material.

In one embodiment, the battery assembly 200 according to the present disclosure may further comprise a busbar 170 electrically connected to the plurality of battery cells 110, and the insertion space 288 may be located between the plurality of battery cells 110 and the busbar 170.

In one embodiment, the battery assembly 200 according to the present disclosure may further comprise a busbar frame 150 supporting the busbar 170 between the plurality of battery cells 110 and the busbar 170, and the insertion space 288 may be located between the plurality of battery cells 110 and the busbar frame 150.

The busbar assembly 130 may comprise a first busbar 171 electrically connected to the first terminal portion 111 and a first busbar frame 151 supporting the first busbar 171. The first busbar 171 and the first busbar frame 151 may collectively be referred to as a first busbar assembly 131. That is, the first busbar assembly 131 may be electrically connected to the first terminal portion 111 and may serve to support the cell stack 100.

The busbar assembly 130 may further comprise a second busbar 172 electrically connected to the second terminal portion 112 and a second busbar frame 152 supporting the second busbar 172. The second busbar 172 and the second busbar frame 152 may collectively be referred to as a second busbar assembly 132. That is, the second busbar assembly 132 may be electrically connected to the second terminal portion 112 and, together with the first busbar assembly 131, may serve to support the cell stack 100.

Meanwhile, referring to FIG. 3, the insertion space 288 may be formed between the plurality of battery cells 110 and the busbar assembly 130 due to the electrical connection between the terminal portions 111, 112 and the busbar assembly 130.

The insertion space 288 may be a part of the receiving space 280 formed inside the receiving case 210. That is, a part of the receiving space 280 may be a space accommodating the plurality of battery cells 110, and another part of the receiving space 280 may be a space for the insertion space 288.

Accordingly, the insertion space 288 may be formed between the plurality of battery cells 110 and the receiving case 210.

More specifically, the insertion space 288 is a space defined by the respective cell cases 115 of the plurality of battery cells 110, the respective terminal portions 111, 112 of the plurality of battery cells 110, and the busbar 170. Typically, when thermal runaway occurs in one of the plurality of battery cells 110 and off-gas is generated, high-temperature heat may be propagated to another adjacent battery cell through the insertion space 288. In order to prevent such thermal propagation (TP), the insertion space 288 needs to be filled with another refractory (fire-retardant or heat-resistant) material.

To this end, the battery assembly 200 according to the present disclosure may comprise a filler member 270 (see FIG. 4) inserted and positioned in the insertion space 288.

Referring to FIGS. 2 and 3, the receiving case 210 may comprise a body bottom side 2194 forming a bottom surface of the receiving case 210, and a first body side 2191 and a second body side 2192 extending from the body bottom side 2194, facing each other with the plurality of battery cells 110 interposed therebetween along the stacking direction, and forming both side surfaces 2191, 2192 of the receiving case 210. The insertion space 288 may comprise a first insertion space 2881 formed between the plurality of battery cells 110 and the first body side 2191, and a second insertion space 2882 formed between the plurality of battery cells 110 and the second body side 2192.

The filler member 270 may be positioned in the first insertion space 2881 and the second insertion space 2882.

In the present disclosure, the position of the filler member 270 is not limited thereto. For example, the filler member 270 may be positioned between an upper surface of the receiving case 210 (or the receiving cover 215) and the plurality of battery cells 110.

To this end, the insertion space 288 may further comprise a third insertion space (not shown) formed between the plurality of battery cells 110 and the upper surface of the receiving case 210 (or between the plurality of battery cells 110 and the receiving cover 215).

That is, the third insertion space may be formed in at least one of between the support frame 155 and the plurality of battery cells 110, or between the support frame 155 and the receiving cover 215.

Meanwhile, referring to FIG. 3, the buffer member 117 or the heat blocking member 119 may be positioned between the plurality of battery cells 110. The buffer member 117 or the heat blocking member 119 may be provided between each of the plurality of battery cells 110. Alternatively, the buffer member 117 or the heat blocking member 119 may be positioned between battery groups BG1 to BG5 in which adjacent battery cells 110 are grouped into a predetermined number of groups.

The battery groups BG1 to BG5 refer to sets of battery cells 110 in which adjacent battery cells 110 among the plurality of battery cells 110 are grouped into a predetermined number of groups. The plurality of battery cells 110 may be grouped into the predetermined number of groups for a predetermined target voltage or target current, and the battery groups BG1 to BG5 may be connected in series or in parallel using the busbar 170.

Meanwhile, along a direction from the first busbar frame 151 toward the second busbar frame 152, a length of the heat blocking member 119 may be longer than a length of the cell case 115. More specifically, the heat blocking member 119 may be in contact with the first busbar assembly 131 and the second busbar assembly 132. Through this, the heat blocking member 119 may block or delay the propagation of heat or flame to another place when thermal runaway occurs in any battery cell 110.

The insertion space 288 may comprise a first insertion space 2881 formed between the plurality of battery cells 110 and one side surface of the receiving case 210 extending along the stacking direction, and a second insertion space 2882 formed between the plurality of battery cells 110 and the other side surface of the receiving case 210 facing the one side surface of the receiving case 210, and the filler member 270 may be disposed in at least one of the first insertion space 2881 and the second insertion space 2882.

FIG. 4 is an enlarged view of portion S1 of FIG. 3.

Specifically, the portion S1 may be a part of the insertion space 288. The battery assembly 200 may further comprise an insertion space 288 formed between the plurality of battery cells 110 and the busbar 170.

More specifically, the insertion space 288 may comprise a first insertion space 2881 (see FIG. 3) between one side surface of each cell case 115 of the plurality of battery cells 110 and the first busbar 171, and a second insertion space 2882 (see FIG. 3) between the other side surface of each cell case 115 of the plurality of battery cells 110 and the second busbar 172.

Referring to FIGS. 3 and 4, the filler member 270 may be positioned in at least one of the first insertion space 2881 or the second insertion space 2882. That is, the filler member 270 may be positioned in at least one of the first insertion space 2881, the second insertion space 2882, or the second insertion space 2882.

More specifically, the portion S1 of FIG. 4 illustrates a part of the first insertion space 2881. One side surface of the cell case 115 may be a side where the first terminal portion 111 is located, and the other side surface of the cell case 115 may be a side where the second terminal portion 112 is located.

Meanwhile, the first insertion space 2881 may be divided by the first terminal portion 111. In addition, the second insertion space 2882 may be divided by the second terminal portion 112. However, when the cell stack 100 is accommodated in the receiving body 219, lengths of the first terminal portion 111 and the second terminal portion 112 in a height direction of the receiving case 210 or the receiving body 219 are smaller than a height of the battery cell 110, and thus the first insertion space 2881 and the second insertion space 2882 may each be in communication.

In addition, the first insertion space 2881 and the second insertion space 2882 may communicate with each other through a space between the plurality of battery cells 110 and the receiving cover 215. Accordingly, the first insertion space 2881 and the second insertion space 2882 may not be isolated spaces separated from each other, but may be spaces capable of communicating with each other.

FIG. 4 illustrates the first insertion space 2881; however, the description of the first insertion space 2881 may also be equally applied to the second insertion space 2882. In addition, the description of the insertion space 288 may be applied equally to the first insertion space 2881 and the second insertion space 2882 without distinguishing between them.

Referring to FIGS. 2 and 4, the receiving case 210 may comprise a receiving body 219 including an opening 2195 on one side and accommodating the plurality of battery cells 110, and a receiving cover 211 coupled to the receiving body 219 and covering the opening 2195, and the filler member 270 may extend in a direction (Z-direction or a height direction of the receiving case 210) from the receiving body 219 toward the receiving cover 211.

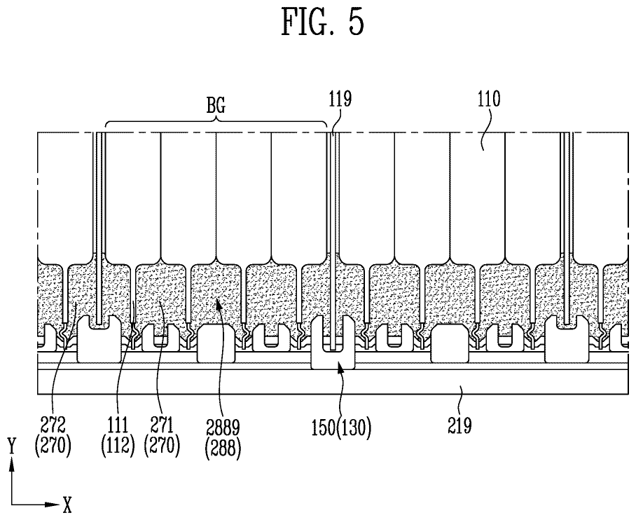

FIG. 5 schematically illustrates an embodiment of a filler member 270 accommodated in an insertion space 288 viewed from above.

The insertion space 288 may be formed between the respective cell cases 115 of the plurality of battery cells 110 and the busbar assembly 130.

The insertion space 288 may be formed as each terminal portion 111, 112 is connected to the busbar assembly 130 (or the busbar 170).

Meanwhile, the insertion space 288 may be partitioned into a plurality of separate spaces 2889 by the respective terminal portions 111, 112 of the plurality of battery cells 110.

Specifically, each of the plurality of battery cells 110 may comprise an electrode assembly 113, a cell case 115 accommodating the electrode assembly 113 therein, and terminal portions 111, 112 electrically connected to the electrode assembly 113 and protruding to an outside of the cell case 115, and the insertion space 288 may be partitioned into a plurality of separate spaces 2889 by the respective terminal portions 111, 112 of the plurality of battery cells 110.

In addition, the battery assembly 200 according to the present disclosure may further comprise a busbar 170 electrically connected to the plurality of battery cells 110, and a busbar frame 150 supporting the busbar 170 between the plurality of battery cells 110 and the busbar 170, and the plurality of separate spaces 2889 may each be formed by the busbar frame 150, the respective terminal portions 111, 112, and the respective cell cases 115 of the plurality of battery cells 110.

Specifically, each of the plurality of battery cells 110 may comprise an electrode assembly 113, a cell case 115 accommodating the electrode assembly 113 therein, a first terminal portion 111 electrically connected to the electrode assembly 113 and protruding from the cell case 115 toward the first body side 2191, and a second terminal portion 112 electrically connected to the electrode assembly 113 and protruding from the cell case 115 toward the second body side 2192, and the first insertion space 2881 and the second insertion space 2882 may each be partitioned into a plurality of separate spaces 2889 by the respective first terminal portions 111 and the respective second terminal portions 112 of the plurality of battery cells 110.

Further, the filler member 270 may be provided in plurality, and the plurality of filler members 270 may be respectively disposed in at least some of the plurality of separate spaces 2889.

Even if the filler member 270 is disposed only in some of the separate spaces 2889, thermal propagation (TP) can be prevented, and thus the filler member 270 does not necessarily need to be disposed in all of the separate spaces 2889.

In addition, referring to FIG. 5, the plurality of filler members 270 may be disposed in the plurality of separate spaces 2889 at a predetermined interval along the stacking direction.

That is, the battery assembly 200 according to the present disclosure may further comprise a heat blocking member 119 disposed between at least one pair of the plurality of battery cells 110 along the stacking direction, and the heat blocking member 119 may extend toward the busbar frame 150 or extend parallel to the plurality of battery cells, and may be inserted into a filler member 270 among the plurality of filler members 270 disposed to correspond to the heat blocking member 119.

Accordingly, the filler member 270 may comprise a first filler member 271 disposed between two adjacent battery cells 110 among the plurality of battery cells 110, and a second filler member 272 disposed between two adjacent battery cells 110 among the plurality of battery cells 110, a part of the heat blocking member 119 being inserted into the second filler member 272.

Accordingly, referring to FIGS. 1, 2, and 5, the plurality of separate spaces 2889 may each be formed by the busbar frame 150, the respective cell cases 115, and the respective terminal portions 111, 112.

More specifically, the terminal portions 111, 112 may comprise a first terminal portion 111 partitioning the first insertion space 2881, and a second terminal portion 112 partitioning the second insertion space 2882, and the first insertion space 2881 and the second insertion space 2882 may each be partitioned into a plurality of separate spaces 2889 by the first terminal portions 111 and the second terminal portions 112, respectively.

The terminal portions 111, 112 do not completely isolate the plurality of separate spaces 2889. That is, since lengths of the respective terminal portions 111, 112 in a height direction of the receiving case 210 are smaller than a height of the receiving space 280, they only partially partition along the height of the receiving space 280.

That is, since lengths of the respective terminal portions 111, 112 in the height direction of the receiving case 210 are smaller than lengths of the respective cell cases 115, the plurality of separate spaces 2889 may be partitioned by the respective terminal portions 111, 112, but may also be in communication with each other.

Accordingly, as described above, the plurality of separate spaces 2889 may be capable of communicating with each other. In addition, the filler members 270 may also be provided in plurality and may be respectively inserted into the plurality of separate spaces 2889.

Meanwhile, the filler member 270 may be formed of a material that is injected in a liquid state during assembly of the battery assembly 200 and then cured. Alternatively, the filler member 270 may be a solid pre-processed to have a predetermined shape so as to be disposed in the plurality of separate spaces 2889 or the insertion space 288.

Accordingly, considering that the plurality of separate spaces 2889 are in communication with each other, when the filler member 270 is formed of a material that is injected in a liquid state and then cured, the filler member 270 may be cured after injection and integrated.

As described above, in the present disclosure, the position of the filler member 270 is not limited to positions on both sides of the plurality of battery cells 110. For example, the filler member 270 may be positioned between the plurality of battery cells 110 and an upper surface of the receiving case 210 (or between the plurality of battery cells 110 and the receiving cover 215).

To this end, a viscosity of the filler member 270 in a liquid state before curing may be 160 cP (centipoise) or more.

If a viscosity of the filler member 270 is less than 160 cP, it may be difficult to fill with a desired amount when injected in a liquid state because leakage may occur to the outside of the battery assembly, and it may act as a foreign substance in portions requiring electrical connection, such as the busbar 170, causing performance degradation or malfunction.

Specifically, the viscosity of the filler member 270 may be a viscosity in a liquid state and may range from 160 cP to 40,000 cP. Since the filler member 270 has a viscosity within the above range at room temperature, it can be uniformly filled into the battery cell 110 while preventing leakage of the filler member 270, thereby improving process efficiency.

FIG. 6 illustrates a volume change of the filler member 270 before and after thermal runaway.

In the drawings of FIG. 6, the upper drawing illustrates a state before deformation of the filler member 270, and the lower drawing illustrates an example of a state after deformation of the filler member 270. The filler member 270 may be deformed corresponding to at least one of the battery cells 110 in which gas is generated inside after thermal runaway of the battery cell 110 or after performing multiple cycles.

FIG. 6 shows the filler member 270 spaced apart from the cell case 115 before deformation for clear explanation of the difference in the filler member 270, but the filler member 270 may be filled to be in contact with the cell case 115 even before deformation, as illustrated in FIGS. 3 and 4.

Depending on an operating environment of the battery assembly 200, the battery cells 110 accommodated inside the battery assembly 200 may contract or expand and generate gas. The gas may cause the cell case 115 to expand. At this time, gas generated according to expansion of the cell case 115 may be trapped between the electrode assemblies 113. This may eventually cause lithium plating (Li-plating) and lead to performance degradation of the battery cell 110.

To prevent this, the filler member 270 may be formed of a compressible material. Alternatively, the filler member 270 may have compressibility.

That is, a volume of the filler member 270 may be maintained at a first volume V1, and when at least one of the plurality of battery cells 110 expands, the volume may decrease from the first volume V1 according to the expansion of the at least one battery cell 110.

Referring to FIG. 6, the first volume V1 may be a volume when the filler member 270 is inserted into the insertion space 288. The first volume V1 may be a volume of the filler member 270 before deformation along the protruding direction of the terminal portions 111, 112. That is, the first volume V1 may be a sum of a first-first region volume V1b, which corresponds to a length W2 excluding a depth recessed by deformation of the filler member 270 by the cell case 115, and a first-second region volume V1a, which is a remaining volume other than the first-first region volume V1b.

The first-second region volume V1a may be a volume obtained by subtracting the first-first region volume V1b from the first volume V1 corresponding to the entire length W1 of the filler member 270 before deformation.

The second volume V2 may be a volume of the filler member 270 after being deformed by the cell case 115 expanded due to thermal runaway. Accordingly, the second volume V2 may be a sum of a second-first region volume V2b, which is a volume up to a length W2 excluding a depth recessed by deformation by the cell case 115, and a second-second region volume V2a, which is a remaining volume other than the second-first region volume V2b. The second-second region volume V2a may be a volume of a region in which the largest volume change occurs since it is brought into contact with and deformed by expansion of the cell case 115.

The filler member 270 may not only be deformed at a portion in contact with the cell case 115 but may also cause an overall deformation while being compressed. FIG. 6 merely illustrates the regions of the filler member 270 divided for a schematic explanation of this.

The filler member 270 may be provided in plurality, and when at least one of the plurality of battery cells 110 expands, at least one of the filler members 270 disposed to correspond to the at least one battery cell 110 may be deformed from the first volume V1 to a second volume V2 smaller than the first volume V1.

In one example, when the volume of the filler member 270 is compressed by 20%, the repulsive force of the filler member 270 may be 10 kPa (kilopascal) or greater.

In another example, when the volume of the filler member 270 is compressed by 70%, the repulsive force of the filler member 270 may be 488 kPa or less.

In still another example, when the volume of the filler member 270 is compressed by more than 70% and not more than 90%, the repulsive force of the filler member 270 may be less than 1300 kPa.

The repulsive force of the filler member 270 is a result according to the compression test of ASTM D3574.

The filler member 270, by having the repulsive force in the above-described range, can sense a change in the volume of the battery cell 110 when the volume of the battery cell 110 expands inside the battery assembly 200, and can prevent the volume of the battery cell 110 from expanding beyond a predetermined level.

As described above, the filler member 270 having compressibility according to the present disclosure can prevent the lifetime of the battery cell 110 from drastically decreasing even if the cell case 115 expands.

In addition, the filler member 270 may have at least one of electrical insulation or fire retardancy.

A conventional filler member (or gap filler) may require about 24 hours to cure after being injected in a liquid state in order to exhibit electrical insulation. In contrast, the filler member 270 according to the present disclosure can have electrical insulation immediately even when injected in a liquid state. For this purpose, the filler member 270 may be cured after being injected in a liquid state into the insertion space 288. In addition, the filler member 270 in the liquid state and the filler member 270 after curing may have a resistance value equal to or greater than a predetermined value. The filler member 270 in the liquid state and the cured filler member 270 have a predetermined resistance value or more.

More specifically, the resistance value of the filler member 270 according to the present disclosure may be 100 Mohm or more at direct current 500 V when measuring insulation resistance according to ASTM D149.

In addition, in a withstand voltage test, the current value of the filler member 270 according to the present disclosure may be 0.2 mA or less under an alternating current voltage of 3000 V based on leakage current.

In addition, in order to resist high temperatures and flames, the filler member 270 may further have fire-retardancy.

Alternatively, the filler member 270 may further have fire resistance or heat resistance.

For example, a melting point of the filler member 270 may be higher than a temperature at which the cell case 115 starts to melt.

For example, the melting point of the filler member 270 may be higher than an ignition point of the plurality of battery cells 110. The ignition point of the plurality of battery cells 110 may be a temperature at which venting occurs in the battery cell 110.

Alternatively, for example, the melting point of the filler member 270 may be a temperature of an electrolyte accommodated in the cell case 115 when the cell case 115 is torn or opened in a thermal runaway situation.

Accordingly, when any one of the battery cells 110 begins thermal runaway, the cell case 115 starts to melt, but the filler member 270 may maintain its solid form. This is to prevent the filler member 270 from burning or melting down.

The filler member 270 may be a porous material having voids formed therein. The porous material refers to a material including pores inside. The shape of the pores may be irregular and amorphous.

For example, the filler member 270 may be foamed urethane or foamed silicone. In another example, the filler member 270 may mean a polymer material having a V-0 grade in the UL (Underwriter's Laboratory) 94V test (Vertical Burning Test), which is a flame-retardant standard for polymer materials.

Specifically, the filler member 270 may further include a phosphorus-based, halogen-based, or inorganic flame retardant. Preferably, in the case of the phosphorus-based flame retardant, phosphate compounds, phosphonate compounds, phosphinate compounds, phosphine oxide compounds, phosphazene compounds, and metal salts thereof may be included. These may be used alone or in combination of two or more.

In another specific embodiment, the phosphorus-based flame retardant may be diphenyl phosphate, diaryl phosphate, triphenyl phosphate, tricresyl phosphate, triisyl phosphate, tri(2,6-dimethylphenyl)phosphate, tri(2,4,6-trimethylphenyl)phosphate, tri(2,4-di-tert-butylphenyl)phosphate, tri(2,6-dimethylphenyl)phosphate, bisphenol-A bis(diphenyl phosphate), resorcinol bis(diphenyl phosphate), resorcinol bis[bis(2,6-dimethylphenyl)phosphate], resorcinol bis[bis(2,4-di-tert-butylphenyl)phosphate], hydroquinone bis[bis(2,6-dimethylphenyl)phosphate], hydroquinone bis[bis(2,4-di-tert-butylphenyl)phosphate], oligomeric phosphate ester compounds, and the like, but is not limited thereto. The phosphorus-based flame retardant may be applied in the form of a single compound or a mixture of two or more thereof.

In addition, the filler member 270 may further include any one or a combination of phosphorus-based compounds such as ammonium dihydrogen phosphate ((NH₄)H₂PO₄) or diammonium hydrogen phosphate ((NH₄)₂HPO₄).

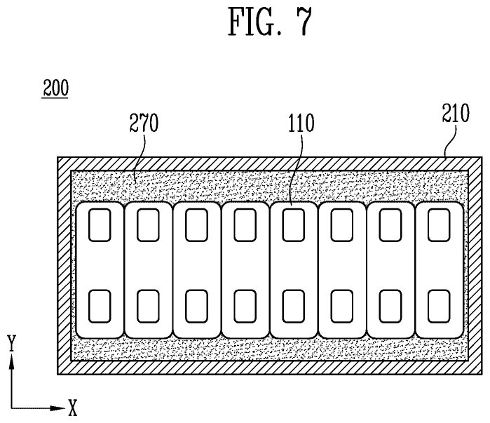

FIG. 7 illustrates a part of another embodiment of the battery assembly 200 according to the present disclosure.

Referring to FIG. 7, the battery cell included in the battery assembly 200 according to the present disclosure may be a prismatic battery cell. That is, the battery assembly 200 according to the present disclosure may include a plurality of battery cells 110 stacked in a predetermined direction, and a filler member 270 disposed between the plurality of battery cells 110.

The filler member 270 may be a material that is injected in a liquefied state and then cured, or may be a pre-molded solid filler shaped to fit into the space between the plurality of battery cells 110 and the receiving case 210.

Meanwhile, the terminals of the prismatic battery cell 110 may be located at the upper portion of the prismatic battery cell 110 along the height direction of the receiving case. That is, the busbar for electrically connecting the plurality of battery cells 110 may be located at the upper portion of the plurality of battery cells 110. Accordingly, the filler member 270 may also be located between the receiving case 210 and the upper portion of the plurality of battery cells 110.

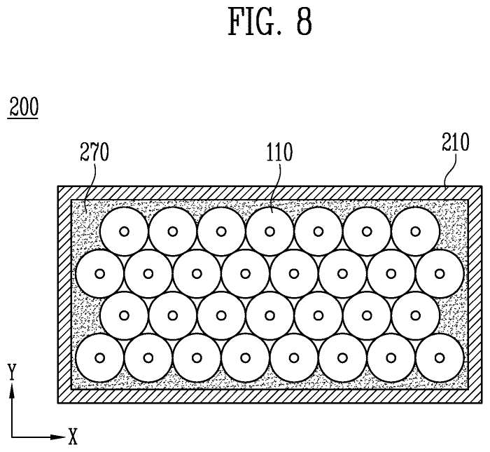

FIG. 8 illustrates a part of another embodiment of the battery assembly according to the present disclosure.

Referring to FIG. 8, the battery cell included in the battery assembly 200 according to the present disclosure may be a cylindrical battery cell. That is, the battery assembly 200 according to the present disclosure may include a plurality of battery cells 110 stacked in a predetermined direction, and a filler member 270 disposed between the plurality of battery cells 110.

The filler member 270 may be a material that is injected in a liquefied state and then cured, or may be a pre-molded solid filler shaped to fit into the space between the plurality of battery cells 110 and the receiving case 210.

Meanwhile, one of the terminals of the cylindrical battery cell 110 may be located at the upper portion of the cylindrical battery cell 110 along the height direction of the receiving case. That is, the busbar for electrically connecting the plurality of battery cells 110 may be located at the upper portion of the plurality of battery cells 110. Accordingly, the filler member 270 may also be located between the receiving case 210 and the upper portion of the plurality of battery cells 110.

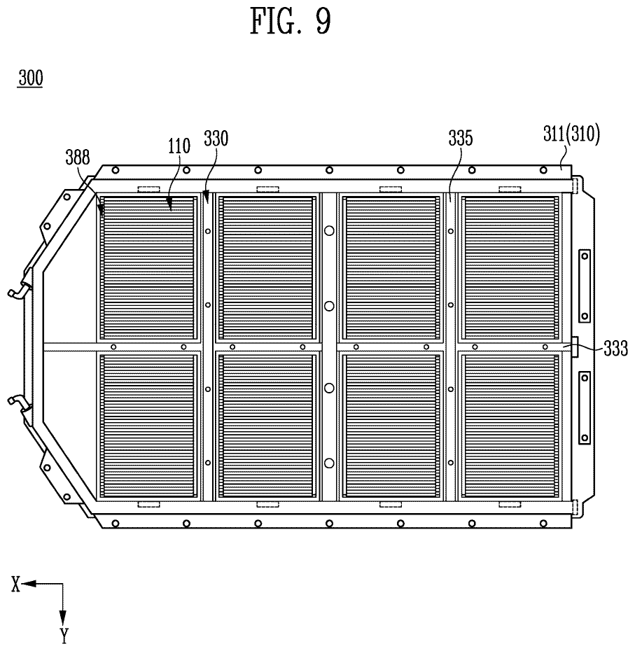

FIG. 9 illustrates another embodiment of the battery assembly according to the present disclosure.

FIG. 9 illustrates another example of a battery assembly 300 provided in the form of a battery pack. That is, the battery assembly 200 may be in the form of a CTP (Cell to Pack) structure, in which the battery module is omitted and a plurality of battery cells 110 are directly accommodated in the form of a pack.

The battery assembly 300 may include a plurality of battery cells 110 stacked and arranged in a predetermined stacking direction, a receiving case 310 that accommodates the plurality of battery cells 110, an insertion space 388 formed between the plurality of battery cells 110 and the receiving case 310 along the stacking direction, and a filler member (not shown) located in the insertion space 388.

The receiving case 310 may include a receiving body 311 that accommodates the plurality of battery cells 110 and a receiving cover (not shown) coupled to the receiving body 311.

In addition, the receiving case 310 may further include a partition portion 330 that separates the plurality of battery cells 110 into a plurality of groups.

The partition portion 330 may further include a first frame 333 and a second frame 335 that partition the plurality of battery cells 110 in transverse and longitudinal directions, respectively. The first frame 333 and the second frame 335 are not only for preventing deformation of the receiving body 311 but also for supporting and separating the plurality of battery cells 110. In addition, the filler member may be located between the plurality of battery cells 110 and the partition portion 330.

Hereinafter, embodiments and comparative examples of the present disclosure will be described. However, the following embodiments are merely preferred embodiments of the present disclosure, and the scope of the present disclosure is not limited by the following embodiments.

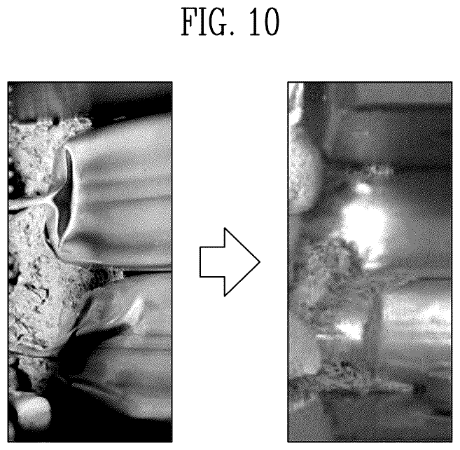

FIG. 10 shows results of a cycle test performed using a battery assembly provided with a filler member according to an embodiment of the present disclosure.

In FIG. 10, a filler member was filled in a battery assembly provided with a pouch-type battery cell, and a cycle test was performed. The pouch-type battery cell was used, and foamed silicone was used as the filler member. In addition, the cycle test was performed by connecting the battery assembly to a charge/discharge device and carrying out 1000 cycles of CC-CV charge/discharge.

Referring to FIG. 10, in the battery assembly according to an embodiment of the present disclosure, even though volume expansion of the pouch-type battery cell occurred inside and conditions similar to an initial thermal runaway situation were present, the foamed silicone as the filler member expanded, exhibited behavior similar to gas venting, and it was confirmed that thermal runaway did not occur.

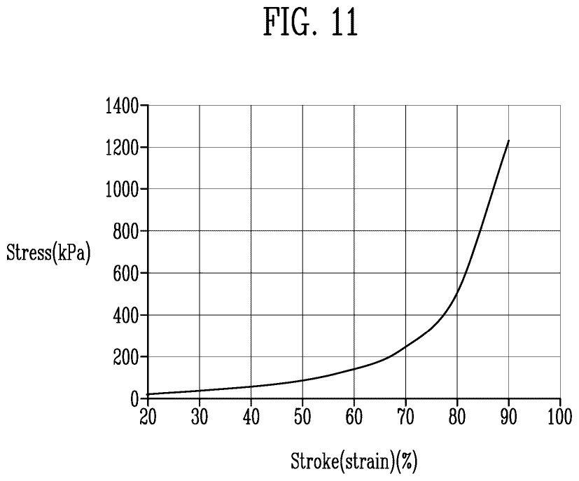

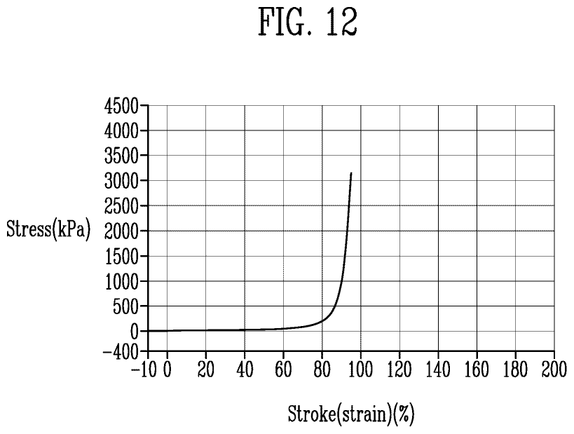

FIG. 11 shows results of measuring an elastic restoring force of the filler member when the volume of the filler member is compressed by 20% according to the present disclosure. FIG. 12 shows results of measuring an elastic restoring force of the filler member when the volume of the filler member is compressed by 70% according to the present disclosure.

In FIGS. 11 and 12, a sample was prepared by cutting foamed silicone, which is the filler member used in the present disclosure, into a box shape having an area of 10 cm×10 cm and a thickness of 1 cm. Using the prepared foamed silicone sample, a compression test according to ASTM D3574 was performed, and the results are shown in FIGS. 11 and 12 and in Table 1. In FIGS. 11 and 12, the x-axis represents stroke (strain) (%) and the y-axis represents stress (kPa).

Table 1 shows the minimum value of the repulsive force obtained by varying the compression ratio of the volume for each sample.

TABLE 1

| | compression ratio of volume | | | | | | | |
|---|---|---|---|---|---|---|---|---|
| | 10% | 20% | 30% | 40% | 50% | 60% | 70% | 80% |
| repulsive force | 6.5 kPa | 10.7 kPa | 16.1 kPa | 23.7 kPa | 34.7 kPa | 53.2 kPa | 91.6 kPa | 205 kPa |

Referring to Table 1, it was confirmed that when the volume of the filler member was compressed, the repulsive force varied depending on the degree of compression, and that as the degree of compression increased, the minimum repulsive force increased. In the case of the filler member according to the present disclosure, when the volume was compressed by 20%, the minimum repulsive force was confirmed to be 10.7 kPa, and when the volume was compressed by 70%, the minimum repulsive force was confirmed to be 91.5 kPa.

Referring to FIG. 11, it was confirmed that the filler member according to an embodiment of the present disclosure exhibited a maximum repulsive force of 120 kPa when the volume was compressed by 20%. In addition, referring to FIG. 12, it was confirmed that the filler member according to an embodiment of the present disclosure exhibited a maximum repulsive force of 488 kPa when the volume was compressed by 70%.

That is, the filler member according to an embodiment of the present disclosure exhibited a predetermined repulsive force depending on the degree of volume compression, and as a result, it was confirmed that the battery cell could be fixed in response to expansion of the battery cell within the battery assembly.

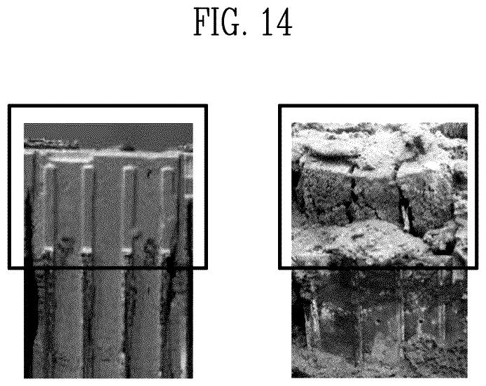

FIG. 13 shows results of measuring insulation resistance of the filler member in each state according to an embodiment of the present disclosure. FIG. 14 is a diagram showing before and after heat source application in a battery assembly including the filler member.

Referring to FIG. 13, the filler member used in the present disclosure was prepared as foamed silicone by mixing Material A (8,500 cps, measured according to ISO 3219) and Material B (9,500 cps, measured according to ISO 3219), and applying heat at 50° C., and the insulation resistance was measured at each stage. Here, the density of the prepared foamed silicone was measured to be 0.386 according to ASTM D792.

In FIG. 13, the insulation resistance before curing (@60 s, 1,000 VDC) appeared as a value exceeding 4,000 MΩ, and the insulation resistance of the foamed silicone manufactured after foaming for 48 hours similarly appeared as a value exceeding 4,000 MΩ. In addition, even after the foamed silicone was immersed in water at room temperature for 24 hours, the insulation resistance similarly appeared as exceeding 4,000 MΩ. That is, it was confirmed that the filler member according to the embodiment of the present disclosure exhibited high insulation resistance.

Referring to FIG. 14, a comparison was made between before applying a heat source (left) and after applying a heat source (right) to the battery assembly using the filler member of FIG. 13. As shown in FIG. 14, while the filler member showed no change, it was confirmed that the battery cell ignited. That is, it was confirmed that the melting point of the filler member was higher than the ignition point of the battery cell.

The present disclosure may be embodied in various forms, and thus the scope of rights is not limited to the above-described embodiments. Therefore, if a modified embodiment includes the constituent elements of the claims of the present disclosure, it shall be considered to fall within the scope of rights of the present disclosure.

What is claimed is:

1. A battery assembly comprising:
a plurality of battery cells;
a receiving case configured to accommodate the plurality of battery cells;
an insertion space formed between the plurality of battery cells and the receiving case; and
a filler member disposed in the insertion space,
wherein the filler member comprises a compressible material.

2. The battery assembly according to claim 1, wherein the filler member has at least one of electrical insulation or fire retardancy.

3. The battery assembly according to claim 1, wherein a volume of the filler member is maintained at a first volume, and when at least one of the plurality of battery cells expands, the volume decreases from the first volume according to the expansion of the at least one battery cell.

4. The battery assembly according to claim 3, wherein the filler member comprises a plurality of filler members, and when at least one of the plurality of battery cells expands, at least one filler member, which is disposed to correspond to the at least one battery cell among the plurality of filler members, is deformed from the first volume to a second volume smaller than the first volume.

5. The battery assembly according to claim 1, further comprising a busbar electrically connected to the plurality of battery cells,
wherein the insertion space is located between the plurality of battery cells and the busbar.

6. The battery assembly according to claim 5, further comprising a busbar frame supporting the busbar between the plurality of battery cells and the busbar,
wherein the insertion space is located between the plurality of battery cells and the busbar frame.

7. The battery assembly according to claim 1, wherein each of the plurality of battery cells comprises:
an electrode assembly;
a cell case configured to accommodate the electrode assembly therein; and
a terminal portion configured to be electrically connected to the electrode assembly and to protrude to an outside of the cell case,
wherein the insertion space is partitioned into a plurality of separate spaces by the respective terminal portions of the plurality of battery cells.

8. The battery assembly according to claim 7, further comprising:
a busbar configured to be electrically connected to the plurality of battery cells; and
a busbar frame configured to support the busbar between the plurality of battery cells and the busbar,
wherein each of the plurality of separate spaces is defined by the busbar frame, the respective terminal portion, and the respective cell case of the plurality of battery cells.

9. The battery assembly according to claim 7, wherein the filler member comprises a plurality of filler members, and the plurality of filler members are respectively disposed in at least some of the plurality of separate spaces.

10. The battery assembly according to claim 9, wherein each of the plurality of filler members is disposed in the plurality of separate spaces at a predetermined interval along the stacking direction.

11. The battery assembly according to claim 9, further comprising a heat blocking member disposed between at least one pair of adjacent battery cells among the plurality of battery cells in the stacking direction,
wherein the heat blocking member extends parallel to the plurality of battery cells and is inserted into a filler member among the plurality of filler members, the filler member being disposed to correspond to the heat blocking member.

12. The battery assembly according to claim 1,
wherein the receiving case comprises:
a body bottom side forming a bottom surface of the receiving case; and
a first body side and a second body side extending from the body bottom side, facing each other with the plurality of battery cells interposed therebetween in the stacking direction, and forming both side surfaces of the receiving case,
wherein the insertion space comprises:
a first insertion space formed between the plurality of battery cells and the first body side; and
a second insertion space formed between the plurality of battery cells and the second body side.

13. The battery assembly according to claim 12, wherein each of the plurality of battery cells comprises:
an electrode assembly;
a cell case configured to accommodate the electrode assembly therein;
a first terminal portion configured to be electrically connected to the electrode assembly and to protrude from the cell case toward the first body side; and
a second terminal portion configured to be electrically connected to the electrode assembly and to protrude from the cell case toward the second body side,
wherein the first insertion space and the second insertion space are respectively partitioned into a plurality of separate spaces by the respective first terminal portions and the respective second terminal portions of the plurality of battery cells.

14. The battery assembly according to claim 1, wherein the receiving case comprises:
a receiving body including an opening on one side and accommodating the plurality of battery cells; and
a receiving cover configured to be coupled to the receiving body and to cover the opening,
wherein the filler member extends in a direction from the receiving body toward the receiving cover.

15. The battery assembly according to claim 1, wherein the filler member is injected into the insertion space in a liquid state and then cured.

16. The battery assembly according to claim 15, wherein the filler member in the liquid state and the cured filler member have a predetermined resistance value or more.

17. The battery assembly according to claim 15, wherein a viscosity of the filler member in the liquid state is 160 cP (centipoise) or more.

18. The battery assembly according to claim 1, wherein, when an elastic restoring force of the filler member is evaluated by a compression test according to ASTM D3574, the filler member has an elastic restoring force of 10 kPa or more when its volume is compressed by 20%, and an elastic restoring force of 488 kPa or less when its volume is compressed by 70%.

19. The battery assembly according to claim 1, wherein, when an insulation resistance of the filler member is evaluated according to ASTM D149, the filler member has a resistance value of 100 MΩ or more at a direct current of 500 V.

20. The battery assembly according to claim 1, wherein the filler member comprises at least one of foamed urethane, foamed silicone, or a polymer material having a first fire-retardant standard, and the first fire-retardant standard includes a V-0 rating in a 94V test (Vertical Burning Test) of UL (Underwriters Laboratories).
